(19) United States
(12) Patent Application Publication
(10) Pub. No.: US 2025/0342562 A1
(43) Pub. Date: Nov. 6, 2025

(54) IMAGE PROCESSING METHODS, DEVICES, ELECTRONIC DEVICES, AND MEDIUMS

(71) Applicant: ZHEJIANG PIXFRA TECHNOLOGY CO., LTD., Hangzhou (CN)

(72) Inventors: Quankai LIU, Hangzhou (CN); Wuping LU, Hangzhou (CN); Jun LI, Hangzhou (CN); Yuan GAO, Hangzhou (CN); Zhenxin CHEN, Hangzhou (CN)

(73) Assignee: ZHEJIANG PIXFRA TECHNOLOGY CO., LTD., Hangzhou (CN)

(21) Appl. No.: 19/267,634

(22) Filed: Jul. 13, 2025

Related U.S. Application Data
(63) Continuation-in-part of application No. PCT/CN2024/072880, filed on Jan. 17, 2024.

(30) Foreign Application Priority Data
Jan. 17, 2023 (CN) 202310090705.6

(51) Int. Cl. G06T 3/4053; G06T 3/4046; G06T 5/60; G06T 5/70

(52) U.S. Cl. CPC G06T 3/4053; G06T 3/4046; G06T 5/60; G06T 5/70; G06T 2207/20084; G06T 2207/30168

(57) ABSTRACT

An image processing method may be provided. The method comprises obtaining a target image to be processed. Further, the method comprises obtaining a detail-enhanced high-resolution image by processing the target image using a trained hybrid attention super-resolution network model, wherein the trained hybrid attention super-resolution network model is a machine learning model, and includes a convolutional layer, a plurality of serially connected attention residual layers, a target residual addition layer, and an upsampling layer.

### CROSS-REFERENCE TO RELATED APPLICATIONS

This application is a continuation-in-part of International Patent Application No. PCT/CN2024/072880, filed on Jan. 17, 2024, which claims priority to Chinese Patent Application No. 202310090705.6, filed on Jan. 17, 2023, the entire contents of which are hereby incorporated by reference.

### TECHNICAL FIELD

The present disclosure relates to the field of image processing technologies, and in particular, to an image processing method, device, electronic device, and medium.

### BACKGROUND

Due to limitations imposed by hardware and cost, thermal imaging images typically have low resolution and insufficiently prominent details. Super-resolution reconstruction can improve the resolution and quality of the images, which can alleviate problems of low resolution and insufficiently prominent details.

However, because the thermal imaging image has less detailed information compared to a visible light image, it is difficult to distinguish between a detailed region and a smooth region in the thermal imaging image. Moreover, when there is a large temperature difference between a target and the surrounding environment, feature extraction in the detailed region are more inaccurate. As a result, after a super-resolution reconstruction is performed on the thermal imaging image using a super-resolution network model, black-and-white edge artifacts may appear in the detailed region of the super-resolution reconstructed image.

Therefore, how to solve the issue of inaccurate feature extraction in blurred detail regions of thermal imaging images, which leads to black-and-white edge artifacts in super-resolution reconstructed images, has become a pressing technical challenge that urgently needs to be addressed.

### SUMMARY

The present disclosure provides an image processing method, device, electronic device, and medium, which are configured to solve the issue of inaccurate feature extraction in blurred detail regions of thermal imaging images, which leads to black-and-white edge artifacts in super-resolution reconstructed images in the related art.

According to an aspect of the present disclosure, an image processing method may be provided. The method comprises obtaining a target image to be processed. Further, the method comprises obtaining a detail-enhanced high-resolution image by processing the target image using a trained hybrid attention super-resolution network model, wherein the trained hybrid attention super-resolution network model is a machine learning model, and includes a convolutional layer, a plurality of serially connected attention residual layers, a target residual addition layer, and an upsampling layer.

In some embodiments, the obtaining of a detail-enhanced high-resolution image by processing the target image using a trained hybrid attention super-resolution network model includes the following operations. Convolutional processing is performed on the target image via the convolutional layer to obtain a shallow feature map. Perceptual processing is performed on the shallow feature map via the plurality of attention residual layers to obtain a deep feature map. The shallow feature map and the deep feature map are processed via the target residual addition layer to obtain a target feature map. The detail-enhanced high-resolution image is obtained by processing the target feature map via the upsampling layer.

In some embodiments, the perceptual processing performed via the plurality of attention residual layers on the shallow feature map to obtain a deep feature map includes the following operations. For each attention residual layer of the plurality of attention residual layers, a first input feature map of the attention residual layer is determined, wherein the shallow feature map is designated as the first input feature map when the attention residual layer is the first attention residual layer among the plurality of attention residual layers, or at least one output feature map of at least one previous attention residual layer is designated as the first input feature map when the attention residual layer is not the first attention residual layer. The perceptual processing is performed on the first input feature map via the attention residual layer to obtain an output feature map of the attention residual layer. The output feature map outputted by the last attention residual layer among the plurality of attention residual layers is designated as the deep feature map.

In some embodiments, each attention residual layer includes an attention layer and a residual addition layer, and the perceptual processing performed via the attention residual layer on the first input feature map to obtain an output feature map of the attention residual layer includes the following operations. The perceptual processing is performed on the first input feature map via the attention layer to obtain a target attention feature map. An element-wise addition is performed on the target attention feature map and the first input feature map via the residual addition layer to obtain the output feature map of the attention residual layer.

In some embodiments, each attention residual layer further includes a first convolutional layer, a first activation layer, a second convolutional layer, and a second activation layer, and before the perceptual processing is performed via the attention layer on the first input feature map to obtain a target attention feature map, and the method further includes the following operations. The first input feature map is processed via the first convolutional layer to obtain a first convolutional feature map. The first convolutional feature map is processed via the first activation layer to obtain a first activation feature map. The first activation feature map is processed via the second convolutional layer to obtain a second convolutional feature map. The second convolutional feature map is processed via the second activation layer to obtain a second input feature map. The second input feature map is input into the attention layer of the attention residual layer for a subsequent processing.

In some embodiments, each attention residual layer further includes a scale prediction layer, and the performing, via the first convolutional layer, convolutional processing on the first input feature map to obtain a first convolutional feature map includes the following operations. The first input feature map is processed via the scale prediction layer to obtain a scale feature map. The first input feature map and the scale feature map are processed via the first convolutional layer to obtain the first convolutional feature map.

In some embodiments, each attention residual layer includes a processing unit, a first perceptron unit, a second perceptron unit, a fusion layer unit, and an element-wise multiplication unit, and the performing, via the attention layer, the perceptual processing on the first input feature map to obtain a target attention feature map includes the following operations. The first input feature map is processed via the processing unit to obtain a local binary pattern (LBP) feature value matrix. The perceptual processing is performed via the first perceptron unit on the first input feature map to obtain a brightness-based attention feature map. The perceptual processing is performed via the second perceptron unit on the LBP feature value matrix to obtain a gradient-based attention feature map. Fusion processing is performed via the fusion layer unit on the brightness-based attention feature map and the gradient-based attention feature map to obtain a fused attention feature map. Element-wise multiplication processing is performed via the element-wise multiplication unit on the fused attention feature map and the first input feature map to obtain the target attention feature map.

In some embodiments, each attention residual layer further includes a scale prediction layer, and the performing, via the attention layer, the perceptual processing on the first input feature map to obtain a target attention feature map includes the following operations. The first input feature map is processed via the scale prediction layer to obtain a scale feature map. The perceptual processing is performed via the attention layer on the first input feature map and the scale feature map to obtain the target attention feature map.

In some embodiments, the trained hybrid attention super-resolution network model further includes a noise estimation layer, and the performing, via the plurality of attention residual layers, perceptual processing on the shallow feature map to obtain a deep feature map includes the following operations. The target image is processed via the noise estimation layer to obtain a noise estimation image. The perceptual processing is performed via the plurality of attention residual layers on the shallow feature map and the noise estimation image to obtain the deep feature map.

In some embodiments, a terminal device is controlled to display the detail-enhanced high-resolution image.

According to another aspect of the present disclosure, an image processing system may be provided. The system may include at least one storage device including a set of instructions and at least one processor in communication with the at least one storage device. When the set of instructions is executed, the system is configured to be directed to perform the operations. The system may obtain a target image to be processed. Further, the system may obtain a detail-enhanced high-resolution image by processing the target image using a trained hybrid attention super-resolution network model, wherein the trained hybrid attention super-resolution network model is a machine learning model, and includes a convolutional layer, a plurality of serially connected attention residual layers, a target residual addition layer, and an upsampling layer.

According to yet another aspect of the present disclosure, a non-transitory computer readable medium may be provided. The non-transitory computer readable medium comprises at least one set of instructions, wherein when executed by one or more processors of a computing device, the at least one set of instructions causes the computing device to perform a method. The method comprises obtaining a target image to be processed. Further, the method comprises obtaining a detail-enhanced high-resolution image by processing the target image using a trained hybrid attention super-resolution network model, wherein the trained hybrid attention super-resolution network model is a machine learning model, and includes a convolutional layer, a plurality of serially connected attention residual layers, a target residual addition layer, and an upsampling layer.

### BRIEF DESCRIPTION OF THE DRAWINGS

In order to more clearly illustrate the technical solutions in the embodiments of the present disclosure, brief introductions of the drawings required for describing the embodiments are provided below. It is apparent that the drawings described below are merely some embodiments of the present disclosure. Other drawings may also be obtained by those of ordinary skill in the art without creative efforts based on these drawings.

FIG. 1 is a schematic diagram illustrating an image processing process according to some embodiments of the present disclosure;

FIG. 2 is a schematic diagram illustrating an image processing process according to some embodiments of the present disclosure;

FIG. 3 is a schematic diagram illustrating a process for determining a target attention feature map via an attention layer according to some embodiments of the present disclosure;

FIG. 4 is a schematic diagram illustrating a process for extracting an output feature map via an attention residual layer according to some embodiments of the present disclosure;

FIG. 5 is a schematic diagram illustrating a structure of an image processing device according to some embodiments of the present disclosure; and

FIG. 6 is a schematic diagram illustrating a structure of an electronic device according to some embodiments of the present disclosure.

### DETAILED DESCRIPTION

In order to make the objectives, technical solutions, and advantages of the present disclosure more clearly understood, the present disclosure is described in further detail below with reference to the accompanying drawings. It is apparent that the embodiments described are only a portion of the embodiments of the present disclosure rather than all embodiments. All other embodiments obtained by those of ordinary skill in the art without creative efforts based on the embodiments of the present disclosure also fall within the scope of protection of the present disclosure.

To solve the issue of inaccurate feature extraction in blurred detail regions of thermal imaging images, which leads to black-and-white edge artifacts in super-resolution reconstructed images, the embodiments of the present disclosure provide an image processing method, device, electronic device, and medium.

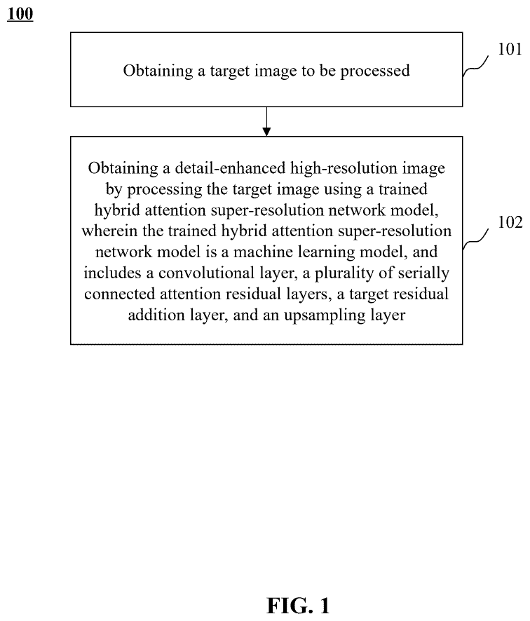

FIG. 1 is a schematic diagram illustrating an image processing process according to some embodiments of the present disclosure. The process comprises the following operations.

In S101, a target image to be processed is obtained.

To solve the issue of inaccurate feature extraction in blurred detail regions of thermal imaging images, which leads to black-and-white edge artifacts in super-resolution reconstructed images, an image processing method is provided in some embodiments of the present disclosure, which is applied to an electronic device. The electronic device may be a host, a tablet, a smartphone, or another type of intelligent terminal device, or be a server. The server may be a local server or a cloud server. The embodiments of the present disclosure impose no limitation on the type of electronic device.

The electronic device obtains a target image to be processed. The target image refers to an image that needs to be processed. The target image may be a thermal imaging image or a low-resolution image with blurred detailed regions, such as an infrared image or a visible light image. The electronic device may obtain the target image to be processed in various ways. For example, the electronic device may receive the target image sent from another electronic device (e.g., a thermal imager) connected thereto, or may obtain the target image from the electronic device.

In S102, a detail-enhanced high-resolution image (also referred to as a high-resolution image) is obtained by processing the target image using a trained hybrid attention super-resolution network model, wherein the trained hybrid attention super-resolution network model is a machine learning model and includes a convolutional layer, a plurality of serially connected attention residual layers, a target residual addition layer, and an upsampling layer.

The hybrid attention super-resolution network model is configured to perform a super-resolution reconstruction on a low-resolution image. A loss function of the hybrid attention super-resolution network model is defined as L=MSE (lr, hr), where L represents a loss value, lr represents a low-resolution image, hr represents a high-resolution image, and MSE denotes a mean squared error. The convolutional layer of the hybrid attention super-resolution network model is used to perform convolutional processing on the target image to obtain the shallow feature map of the target image. In some embodiments, the hybrid attention super-resolution network model is configured to perform super-resolution reconstruction on an image based on an attention mechanism. The attention mechanism is a technique in artificial neural networks that simulates cognitive attention. The attention mechanism can enhance weights of certain parts of input data of a neural network while reducing weights of other parts, thereby focusing the attention of the network on a small portion of the data that is most important. The attention mechanism may be implemented by incorporating an attention function or introducing other structures for realizing attention into the hybrid attention super-resolution network model architecture. In some embodiments, an input of the hybrid attention super-resolution network model may include the target image, and an output of the hybrid attention super-resolution network model may include a detail-enhanced high-resolution image.

In some embodiments, a shallow feature map is obtained by processing the target image via the convolutional layer. A deep feature map is obtained by processing the shallow feature map via the plurality of attention residual layers. In some embodiments, the trained hybrid attention super-resolution network model further includes a noise estimation layer. A noise estimation image is obtained by processing the target image via the noise estimation layer. The deep feature map is obtained by performing, via the plurality of attention residual layers, perceptual processing on the noise estimation image and the shallow feature map. Values of the noise estimation image may reflect noise intensities or signal confidences (i.e., signal reliabilities) of image dada corresponding to different points of the target image. For example, if the value of a point in the noise estimation image is high, the image data of the corresponding point in the target image has the strong noise or the low confidence. By using the noise estimation image, the trained hybrid attention super-resolution network model can be assisted in distinguishing signals from noise and guided to focus on high-quality image data, thereby outputting a high-resolution image with higher quality, reduced noise, and fewer artifacts.

Further, the shallow feature map and the deep feature map are processed via the target residual addition layer to obtain a target feature map. Then, the detail-enhanced high-resolution image is obtained by processing the target feature map via the upsampling layer. In some embodiments, a terminal device is controlled to display the detail-enhanced high-resolution image.

In some embodiments, perceptual processing is sequentially performed on the shallow feature map via each attention residual layer of a plurality of serially connected attention residual layers in the trained hybrid attention super-resolution network model to obtain a deep feature map output by the last attention residual layer; an element-wise addition is performed on corresponding pixels of the shallow feature map and the deep feature map via a target residual addition layer of the hybrid attention super-resolution network model to obtain a target feature map; and a detail-enhanced high-resolution image is obtained by inputting the target feature map into an upsampling layer of the hybrid attention super-resolution network model.

In some embodiments, the hybrid attention super-resolution network model includes a convolutional layer, a plurality of attention residual layers, a target residual addition layer, and an upsampling layer. An output of the convolutional layer serves as an input of the plurality of attention residual layers. The output of the convolutional layer and an output of the plurality of attention residual layers serve as an input of the target residual addition layer. An output of the target residual addition layer serves as an input of the upsampling layer, and an output of the upsampling layer serves as a final output of the hybrid attention super-resolution network model.

The convolutional layer is configured to extract shallow features from the target image to obtain the shallow feature map. The input of the convolutional layer includes the target image, and the output of the convolutional layer includes the shallow feature map. The convolutional layer may include a convolutional neural network (CNN), or the like.

An attention residual layer is configured to extract deep features from a target image. The input of the attention residual layer includes a first input feature map, where the first input feature map may be the shallow feature map output by the convolutional layer and/or an output feature map output by at least one previous attention residual layer (e.g., the adjacent previous attention residual layer). In some embodiments, the input of the attention residual layer further includes a noise estimation image. The output of the attention residual layer includes an output feature map. The output feature map of the last attention residual layer may be referred to as the deep feature map. The attention residual layer may include a residual attention network (RAN), or the like. In some embodiments, the first input feature map may include at least two output feature maps output by previous attention residual layers. In this way, feature reuse can be promoted, gradient vanishing may be alleviated, and information flow can be enhanced.

In some embodiments, for each attention residual layer of the plurality of attention residual layers, a first input feature map of the attention residual layer is determined. The first input feature map is the shallow feature map when the attention residual layer is the first attention residual layer among the plurality of attention residual layers, or the first input feature map is at least one output feature map of at least one previous attention residual layer (e.g., an output feature map of the adjacent previous attention residual layer) when the attention residual layer is not the first attention residual layer. As used herein, a previous attention residual layer of an attention residual layer refers to one attention residual layer that is arranged before the attention residual layer in the data processing order of the hybrid attention super-resolution network model (i.e., in the order from the convolutional layer to the upsampling layer). Furthermore, perceptual processing is performed on the first input feature map via the attention residual layer to obtain a corresponding output feature map. An output feature map outputted by the last attention residual layer among the plurality of attention residual layers is designated as the deep feature map.

In some embodiments, each attention residual layer includes an attention layer and a residual addition layer. A target attention feature map is obtained by performing, via the attention layer, perceptual processing on the first input feature map. Furthermore, an output feature map is obtained by performing, via the residual addition layer, an element-wise addition on the target attention feature map and the first input feature map. In some embodiments, each attention residual layer further includes a first convolutional layer, a first activation layer, a second convolutional layer, and a second activation layer. The first input feature map is processed via the first convolutional layer to obtain a first convolutional feature map. The first convolutional feature map is processed via the first activation layer to obtain a first activation feature map. The first activation feature map is processed via the second convolutional layer to obtain a second convolutional feature map. The second convolutional feature map is processed via the second activation layer to obtain a second input feature map. The second input feature map is processed via the attention layer to obtain the target attention feature map.

The target residual addition layer is configured to perform processing on pixel values of corresponding pixels in at least two images to obtain the target feature map. In some embodiments, the target residual addition layer is configured to perform an element-wise addition on the pixel values of corresponding pixels in the at least two images. The inputs of the target residual addition layer include the shallow feature map and the deep feature map, and an output of the target residual addition layer includes the target feature map. The target residual addition layer may include a residual neural network (ResNet), or the like.

The upsampling layer is configured to enhance a resolution of an image. An input of the upsampling layer includes the target feature map, and an output of the upsampling layer includes the detail-enhanced high-resolution image. The upsampling layer may include a fully convolutional network (FCN), a convolutional network for image segmentation (U-Net), or the like.

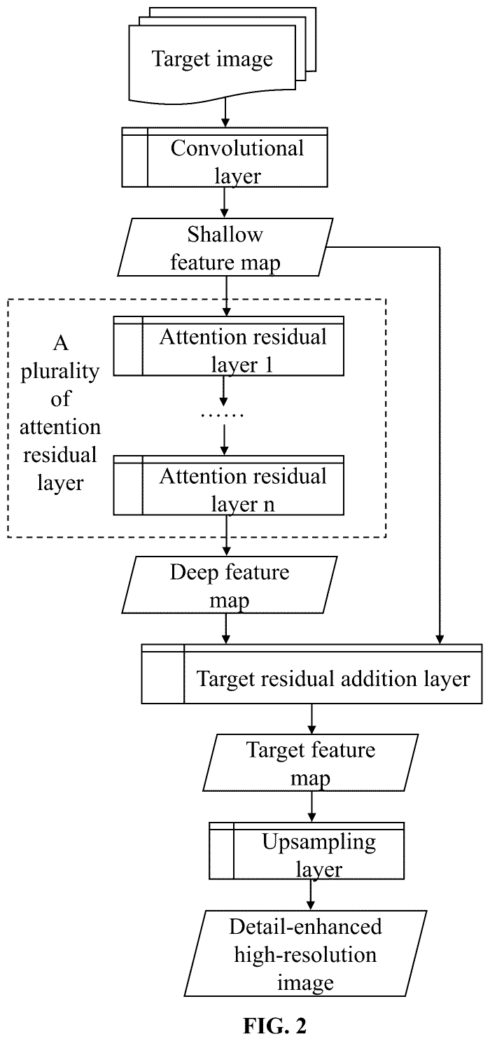

More descriptions regarding the hybrid attention super-resolution network model may be found in elsewhere of the present disclosure (e.g., FIGS. 2-4).

In some embodiments, the hybrid attention super-resolution network model may be trained based on a large amount of training samples with labels. Specifically, the training samples are input into the hybrid attention super-resolution network model, and parameters of the hybrid attention super-resolution network model are updated through training.

In some embodiments, a training sample may be a sample target image. In some embodiments, a label may be a detail-enhanced high-resolution image corresponding to the sample target image. In some embodiments, the label may be obtained using super-resolution techniques such as interpolation algorithms or image reconstruction. The interpolation algorithms may include a nearest-neighbor interpolation algorithm, a bilinear interpolation algorithm, or a bicubic interpolation algorithm. The image reconstruction may include wavelet transform, or the like. In some embodiments, the convolutional layer, the attention residual layers, the target residual addition layer, and the upsampling layer may be jointly trained. A plurality of training samples may be used to train an initial convolutional layer, initial attention residual layers, an initial target residual addition layer, and an initial upsampling layer. Specifically, a sample target image is input into the initial convolutional layer to obtain a sample shallow feature map. The sample shallow feature map is input into the initial attention residual layers to obtain a sample deep feature map. The sample shallow feature map and the sample deep feature map are input into the initial target residual addition layer to obtain a sample target feature map. The sample target feature map is input into the initial upsampling layer to obtain a detail-enhanced high-resolution image corresponding to the sample target image. A loss function is constructed based on the sample target image and the corresponding detail-enhanced high-resolution image. Parameters of the initial convolutional layer, initial attention residual layers, initial target residual addition layer, and initial upsampling layer are simultaneously updated based on the loss function until a preset condition is satisfied. Trained convolutional layer, attention residual layers, target residual addition layer, and upsampling layer are thus obtained. The preset condition may include that the loss function is less than a threshold, the training is converged, or a training cycle reaches a threshold. In some embodiments, the training may be performed based on training samples using various methods. For example, the hybrid attention super-resolution network model may be trained based on a gradient descent method.

In some embodiments, during training, the loss function of the hybrid attention super-resolution network model is defined as L=MSE (lr, hr), where L represents a loss value, lr represents a sample target image (which is a low-resolution image), hr represents a detail-enhanced high-resolution image corresponding to the sample target image, and MSE denotes a mean squared error.

To extract the deep feature map of the target image, the hybrid attention super-resolution network model includes the plurality of serially connected attention residual layers after the convolutional layer. A count of the serially connected attention residual layers may be 60, 64, 62, 65, or the like. Preferably, the count is 64.

The electronic device inputs the shallow feature map output by the convolutional layer into the first attention residual layer, and sequentially performs perceptual processing via each attention residual layer. The output feature map of a previous attention residual layer is used as an input feature map of a subsequent attention residual layer, to obtain the deep feature map output by the last attention residual layer.

FIG. 2 is a schematic diagram illustrating an image processing process according to some embodiments of the present disclosure. As shown in FIG. 2, a target image (which is a low-resolution image) is input into a convolutional layer of a hybrid attention neural network model. A shallow feature map output by the convolutional layer is input into the first attention residual layer of n attention residual layers. Perceptual processing is sequentially performed via the n attention residual layers (where n may be, for example, 60, 62, 64, 65, or the like), to obtain a deep feature map output by the last attention residual layer. The deep feature map and the shallow feature map are input into a target residual addition layer to obtain a target feature map output by the target residual addition layer. The target feature map is then input into an upsampling layer to obtain a high-resolution image output by the upsampling layer.

The shallow feature map and the deep feature map are input into the target residual addition layer. Based on pixel values of corresponding pixels in the shallow feature map and the deep feature map, an element-wise addition is performed on the pixel values of the corresponding pixels to obtain a target feature map. The target feature map is input into the upsampling layer to perform upsampling processing on the target feature image, so as to obtain the detail-enhanced high-resolution image output by the upsampling layer.

In the embodiments of the present disclosure, the target image to be processed is obtained. Convolutional processing is performed on the target image via the convolutional layer of the trained hybrid attention super-resolution network model to obtain the shallow feature map. The perceptual processing is sequentially performed on the shallow feature map via each attention residual layer of the plurality of serially connected attention residual layers in the hybrid attention super-resolution network model. Because the plurality of serially connected attention residual layers constructs a deeper network, the hybrid attention super-resolution network model focuses more on detailed regions in the image. The deeper network can accurately extract a deep feature map containing detailed features. The element-wise addition is performed on corresponding pixels of the shallow feature map and the deep feature map. The result is input into the upsampling layer to obtain the detail-enhanced high-resolution image, thereby solving the issue of inaccurate feature extraction in blurred detail regions of thermal imaging images.

In some embodiments, the hybrid attention super-resolution network model may include the plurality of serially connected attention residual layers. That attention residual layers are serially connected refers to using an output of a previous attention residual layer as an input of a subsequent attention residual layer.

By way of example, the count (i.e., the aforementioned n) may be 64. In this case, the hybrid attention super-resolution network model includes 64 serially connected attention residual layers, denoted as attention residual layer 1, attention residual layer 2, . . . , and attention residual layer 64. The shallow feature map output by the convolutional layer is input into the attention residual layer 1 (i.e., the first attention residual layer). An output of the attention residual layer 1 is used as an input of the attention residual layer 2, . . . , and an input of the attention residual layer 64 is an output of the attention residual layer 63. An output of attention residual layer 64 is used as the deep feature map.

In some embodiments, in order to obtain the deep feature map, the sequentially performing perceptual processing on the shallow feature map via each attention residual layer of the plurality of serially connected attention residual layers in the trained hybrid attention super-resolution network model to obtain the deep feature map output by the last attention residual layer includes the following operations.

For each attention residual layer of the hybrid attention super-resolution network model, in response to determining that the attention residual layer is the first attention residual layer, the shallow feature map is designated as a first input feature map of the first attention residual layer, and the first input feature map is input into the first attention residual layer; or in response to determining that the attention residual layer is not the first attention residual layer, an output feature map outputted by at least one previous attention residual layer (e.g., the adjacent previous attention residual layer) is designated as the first input feature map of the attention residual layer and is input into the attention residual layer The perceptual processing is performed on the first input feature map via an attention layer of the attention residual layer to obtain a target attention feature map outputted by the attention layer. An element-wise addition is performed, via a residual addition layer of the attention residual layer, on corresponding pixels of the target attention feature map and the first input feature map to obtain an output feature map of the attention residual layer, and an output feature map of the last attention residual layer is designated as the deep feature map.

In some embodiments, each attention residual layer includes an attention layer and a residual addition layer. A target attention feature map is obtained by performing, via the attention layer, perceptual processing on the first input feature map. In some embodiments, each attention residual layer further includes a scale prediction layer. A scale feature map is obtained by processing the first input feature map via the scale prediction layer. The target attention feature map is obtained by performing the perceptual processing on the first input feature map and the scale feature map via the attention layer. The scale feature map may be used to guide a receptive field range of the attention layer when the attention layer performs perceptual processing on the first input feature map. For each position (referred to as an output position) in the target attention feature map, the attention layer performs perceptual processing based on data from one or more positions (referred to as input positions) in the first input feature map to obtain the value at the output position. The one or more input positions constitute the receptive field range of the attention layer in the first input feature map. Generally, the receptive field ranges used by the attention layer for different output positions are preset and identical, and the perceptual processing is unable to adaptively adjust based on the characteristics of different output positions. Therefore, the present disclosure introduces the scale feature map to set appropriate receptive field ranges for different output positions. For example, the scale feature map includes a receptive field size corresponding to each output position. If the receptive field size is relatively large, the value of the output position may be calculated based on relatively more input positions during perceptual processing; if the receptive field size is relatively small, the value of the output position may be calculated based on relatively fewer input positions. By using the scale prediction layer, the attention residual layer may adaptively process details with different levels of granularity, using a small receptive field to finely characterize fine details and using a large receptive field to capture overall contours.

Further, an element-wise addition is performed, via the residual addition layer, on the target attention feature map and the first input feature map to obtain the output feature map. Specifically, pixel values of corresponding pixels in the target attention feature map and the first input feature map are determined, and an element-wise addition is performed on the corresponding pixels of the target attention feature map and the first input feature map to obtain an output feature map of the attention residual layer. In response to determining that the attention residual layer is not the last attention residual layer, the output feature map is designated as the first input feature map of a subsequent attention residual layer. In response to determining that the attention residual layer is the last attention residual layer, the output feature map is designated as the deep feature map.

In some embodiments, the attention layer may include a transformer model, or the like. The residual addition layer may include a residual neural network (ResNet), or the like. The scale prediction layer may include a convolutional neural network (CNN). For example, the scale prediction layer may include a plurality of convolutional layers and a plurality of activation functions.

In some embodiments, as described above, the attention residual layers may be classified into the first attention residual layer and non-first attention residual layers. The first attention residual layer refers to the first attention residual layer that processes the shallow feature map, and the non-first attention residual layers refer to the remaining attention residual layers other than the first attention residual layer.

The input of the attention layer of the first attention residual layer includes the shallow feature map (also referred to as the first input feature map of the current attention residual layer). In some embodiments, the input of the attention layer of the first attention residual layer further includes the scale feature map. An output of the attention layer of the first attention residual layer includes the target attention feature map of the first attention residual layer. The input of a residual addition layer of the first attention residual layer includes the shallow feature map and the target attention feature map. The output of the residual addition layer of the first attention residual layer includes the output feature map of the first attention residual layer.

The input of the attention layer of a non-first attention residual layer includes the output feature map outputted by at least one previous attention residual layer (e.g., the adjacent previous attention residual layer) (also referred to as the first input feature map of the current attention residual layer). In some embodiments, the input of the attention layer of a non-first attention residual layer further includes the scale feature map. The output of the attention layer of the non-first attention residual layer includes the target attention feature map of the current attention residual layer. The input of the residual addition layer of the non-first attention residual layer includes the target attention feature map of the current attention residual layer and the first input feature map of the current attention residual layer). An output of the residual addition layer of the non-first attention residual layer includes an output feature map of the current attention residual layer.

In some embodiments, the output feature map outputted by the last attention residual layer may be used as the deep feature map and input into the target residual addition layer, where the last attention residual layer refers to the attention residual layer whose output feature map is to be input into the target residual addition layer for further processing.

In some embodiments of the present disclosure, by configuring the plurality of serially connected attention residual layers in the hybrid attention super-resolution network model, the hybrid attention super-resolution network model performs further extraction of deep features of the target image based on the shallow feature map extracted by the convolutional layer and the outputs of each attention residual layer. As a result, the hybrid attention super-resolution network model may focus more on detail regions in the target image, thereby accurately extracting detail features. A deeper network is constructed through residual results to effectively extract deep features, ultimately enhancing the performance of the hybrid attention super-resolution network model in detail enhancement of the target image.

In some embodiments, the attention layer includes a processing unit, a first perceptron unit, a second perceptron unit, a fusion layer unit, and an element-wise multiplication unit. To obtain the target attention feature map, based on the foregoing embodiments, in the embodiments of the present disclosure, the performing perceptual processing on the first input feature map via the attention layer of the attention residual layer to obtain the target attention feature map of the attention layer includes the following operations.

The first input feature map is processed via the processing unit to obtain a local binary pattern (LBP) feature value matrix. The perceptual processing is performed on the first input feature map via the first perceptron unit to obtain a brightness-based attention feature map. The perceptual processing is performed on the LBP feature value matrix via the second perceptron unit to obtain a gradient-based attention feature map. Fusion processing is performed on the brightness-based attention feature map and the gradient-based attention feature map via the fusion layer unit to obtain a fused attention feature map. Element-wise multiplication processing is performed on the fused attention feature map and the first input feature map via the element-wise multiplication unit to obtain the target attention feature map.

To obtain the target attention feature map, after the first input feature map is inputted into the attention layer of the attention residual layer, the first input feature map is first inputted into the processing unit of the attention layer. According to pixel values of pixels in the first input feature map and the pre-stored LBP sampling function, the pixel value of each pixel is inputted into the LBP sampling function to obtain an LBP feature value corresponding to each pixel. According to the LBP feature value of each pixel point and the row and column position where the pixel point is located in the first input feature map, the LBP feature value of each pixel is used as an element value of an element at a corresponding row and column position in the LBP feature value matrix, such that the LBP feature value matrix is obtained and stored in the attention layer.

The first input feature map is inputted into the first perceptron unit of the attention layer to perform the perceptual processing on the first input feature map and obtain the brightness-based attention feature map. The LBP feature value matrix is inputted into the second perceptron unit of the attention layer to perform the perceptual processing on the LBP feature value matrix and obtain the gradient-based attention feature map. The first perceptron unit and the second perceptron unit are multilayered and independent of each other.

The brightness-based attention feature map and the gradient-based attention feature map are inputted into the fusion layer unit of the attention layer for fusion processing, to obtain the fused attention feature map. The fused attention feature map and the first input feature map are inputted into the element-wise multiplication unit of the attention layer for element-wisc multiplication processing. Specifically, the pixel value of each pixel point of the target attention feature map is obtained by multiplying a pixel value of a corresponding pixel point of the fused attention feature map with a pixel value of a corresponding pixel point of the first input feature map.

In some embodiments, the attention layer includes the processing unit, the first perceptron unit, the second perceptron unit, the fusion layer unit, and the element-wise multiplication unit.

The processing unit is configured to extract feature values from the first input feature map to obtain the LBP feature value matrix. The input of the processing unit includes the first input feature map, and the output of the processing unit includes the LBP feature value matrix. In some embodiments, the processing unit may comprise a pre-stored LBP sampling function, which receives a pixel value of each pixel point in the first input feature map as input and outputs a corresponding LBP feature value of each pixel point in the first input feature map. For each pixel point in the first input feature map, the processing unit determines a position of the pixel point in the first input feature map and assigns its LBP feature value as an element value in a corresponding position in the LBP feature value matrix to obtain the LBP feature value matrix. In some embodiments, various modes of the LBP sampling function may be adopted, such as original LBP features, circular LBP features, uniform patterns, or the like.

The first perceptron unit is configured to extract the brightness-based attention feature map from the first input feature map. The input of the first perceptron unit includes the first input feature map, and the output of the first perceptron unit includes the brightness-based attention feature map. The first perceptron unit may be a self-attention network such as a non-local network (NLNet).

The second perceptron unit is configured to extract the gradient-based attention feature map from the first input feature map. An input of the second perceptron unit includes the LBP feature value matrix, and an output of the second perceptron unit includes the gradient-based attention feature map. The second perceptron unit may be gradient-weighted class activation mapping (Grad-CAM), or the like.

In some embodiments, the first perceptron unit and the second perceptron unit are multilayered and mutually independent.

The fusion layer unit is configured to perform fusion processing on the brightness-based attention feature map and the gradient-based attention feature map. An input of the fusion layer unit includes the brightness-based attention feature map and the gradient-based attention feature map, and an output of the fusion layer unit includes the fused attention feature map. The fusion layer unit may be a transformer model, or the like.

The element-wise multiplication unit is configured to perform element-wise multiplication processing on the fused attention feature map and the first input feature map, that is, the pixel value of the pixel point in each position of the fused attention feature map is multiplied by the pixel value of the pixel point in the corresponding position of the first input feature map, to obtain the pixel value of the pixel point in the corresponding position of the target attention feature map. The input of the element-wise multiplication unit comprises the first input feature map and the fused attention feature map, and the output of the element-wise multiplication unit comprises the target attention feature map.

In some embodiments of the present disclosure, the pixel value of each pixel point in the first input feature map is input into the LBP sampling function to obtain the LBP feature value matrix, which is stored in the attention layer. The first input feature map is then input into the first perceptron unit of the attention layer to perform perceptual processing and obtain the brightness-based attention feature map. The LBP feature value matrix is input into the second perceptron unit of the attention layer to perform perceptual processing and obtain the gradient-based attention feature map. The fusion processing is performed on the brightness-based attention feature map and the gradient-based attention feature map. Because both brightness and gradient are simultaneously considered when extracting the target attention feature map, the feature information extracted in the target attention feature map is more accurate and comprehensive.

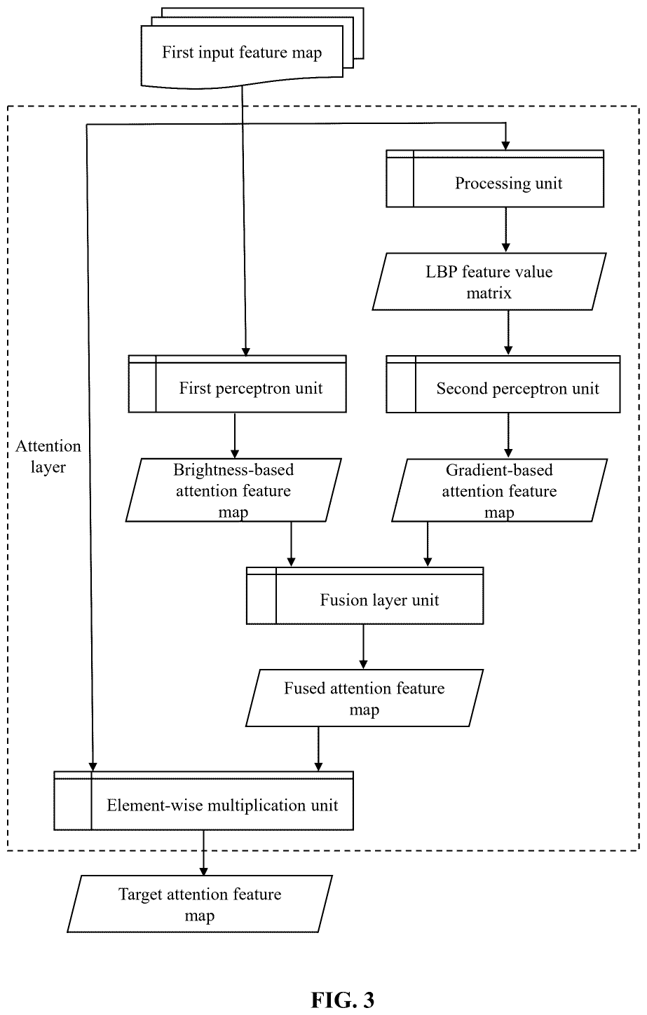

FIG. 3 is a schematic diagram illustrating a process for determining a target attention feature map via an attention layer according to some embodiments of the present disclosure. As shown in FIG. 3, the first input feature map is processed by the first multilayer perceptron and then input into the fusion layer unit. The first input feature map is also processed by the processing unit to obtain the LBP feature value matrix, which is then processed by the second multilayer perceptron and input into the fusion layer unit. The element-wise multiplication processing is performed on the fused attention feature map and the first input feature map to obtain the target attention feature map.

In some embodiments, after obtaining the target image, the electronic device may obtain the LBP feature value matrix based on the target image and the pre-stored LBP sampling function and store the LBP feature value matrix in the attention layer of each attention residual layer.

In one specific embodiment, the process of determining a target attention feature map via the attention layer performed by the present disclosure is described as follows. Based on a first input feature map I and an LBP sampling function Fₛ, pixel values of pixels of the first input feature map are input into the LBP sampling function in the processing unit to obtain an LBP feature value matrix Fea_{Lbp}, where Fea_{Lbp}=Fₛ (I); The first input feature map and the LBP feature value matrix are respectively input into two independent multilayer perceptrons (i.e., the first perceptron unit and the second perceptron unit) to output a brightness-based attention feature map Att_{Luma} and a gradient-based attention feature map Att_{Lbp}, where Att_{Luma}=MLP_{Luma} (Fea_{Luma}), Att_{Lbp}=MLP_{Lbpa} (Fea_{Lbp}), MLP_{Luma} and MLP_{Lbpa} denote the two independent perceptrons, and Fea_{Luma} denotes the first input feature map.

The two attention feature maps are fused in the fusion layer unit to obtain a fused attention feature map Att_{Final}, where Att_{Final}=F_{Fus} (Att_{Lbp}+Att_{Luma}), F_{Fus} denotes the fusion layer unit. The element-wise multiplication processing is performed on the fused attention feature map and the first input feature map to obtain a target attention feature map carrying attention information, F_{Att}=Att_{Final}⊗Fea_{Luma}.

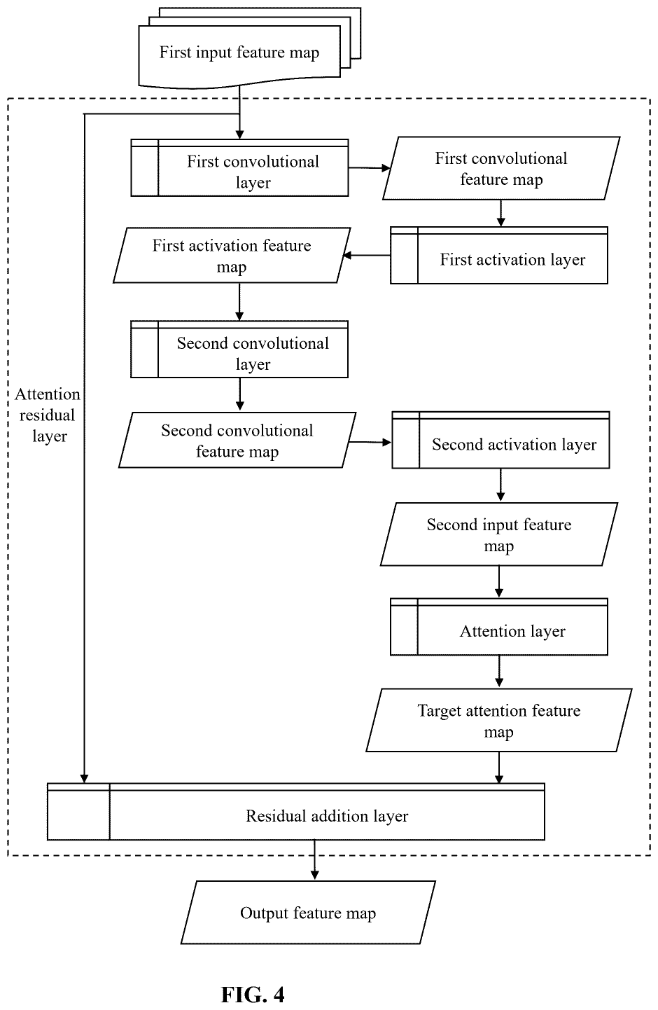

In order to improve the accuracy of feature extraction, on the basis of the foregoing embodiments, some embodiments of the present disclosure further provide that each attention residual layer further includes a first convolutional layer, a first activation layer, a second convolutional layer, and a second activation layer. FIG. 4 is a schematic diagram illustrating a process for extracting an output feature map via an attention residual layer according to some embodiments of the present disclosure. As shown in FIG. 4, before performing the perceptual processing on the first input feature map via the attention layer of the attention residual layer to obtain the target attention feature map outputted by the attention layer, a first convolutional feature map is obtained by performing convolutional processing on the first input feature map via the first convolutional layer. In some embodiments, each attention residual layer further includes a scale prediction layer. A scale feature map is obtained by processing the first input feature map via the scale prediction layer. Furthermore, the first convolutional feature map is obtained by performing, via the first convolutional layer, the convolutional processing on the first input feature map and the scale feature map.

Further, activation processing is performed on the first convolutional feature map via the first activation layer to obtain a first activation feature map. Convolutional processing is performed on the first activation feature map via the second convolutional layer to obtain a second convolutional feature map. Activation processing is performed on the second convolutional feature map via the second activation layer to obtain a second input feature map (also referred to as a second activation feature map). The second input feature map is inputted into the attention layer of the attention residual layer for a subsequent processing.

Then, perceptual processing is performed on the second input feature map via the attention layer to obtain the target attention feature map. An output feature map is obtained by performing an element-wise addition on the target attention feature map and the first input feature map via the residual addition layer.

The first convolutional layer is configured to perform convolutional processing on the first input feature map. The input of the first convolutional layer includes the first input feature map. In some embodiments, the input of the first convolutional layer further includes a scale feature map. The output of the first convolutional layer includes a first convolutional feature map. The first convolutional layer may be a convolutional neural network (CNN), etc.

The first activation layer is configured to perform activation processing on the first convolutional feature map. The input of the first activation layer includes the first convolutional feature map, and the output of the first activation layer includes a first activation feature map. The first activation layer may be implemented using various activation functions, such as a Sigmoid activation function, a hyperbolic tangent (Tanh) activation function, a Rectified Linear Unit (ReLU) activation function, or the like.

The second convolutional layer is configured to perform convolutional processing on the first activation feature map. The input of the second convolutional layer includes the first activation feature map, and the output of the second convolutional layer includes a second convolutional feature map. The second convolutional layer may be a convolutional neural network (CNN), etc.

The second activation layer is configured to perform activation processing on the second convolutional feature map. The input of the second activation layer includes the second convolutional feature map, and the output of the second activation layer includes the second input feature map. The second activation layer may be implemented by using various activation functions, such as a Sigmoid activation function, a hyperbolic tangent (Tanh) activation function, a Rectified Linear Unit (RcLU) activation function, or the like.

In some embodiments of the present specification, by inputting the second input feature map obtained by processing the first input feature map via two successive combinations of convolutional layers and activation layers into the attention layer for computing and adding attention, the resulting target attention feature map and output feature map can more effectively focus on details in the image, thereby enhancing the ability of detail enhancement.

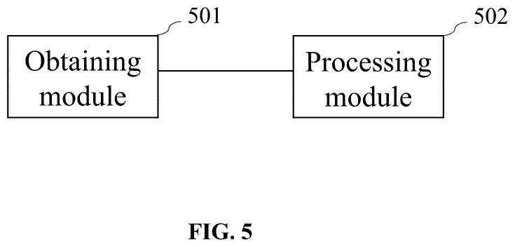

FIG. 5 is a schematic diagram illustrating a structure of an image processing device according to some embodiments of the present disclosure. As shown in FIG. 5, the device comprises an obtaining module 501 and a processing module 502.

The obtaining module 501 is configured to obtain a target image to be processed.

The processing module 502 is configured to obtain a detail-enhanced high-resolution image by processing the target image using a trained hybrid attention super-resolution network model. Specifically, the processing module 502 is configured to perform, via a convolutional layer of a trained hybrid attention super-resolution network model, convolutional processing on the target image to obtain a shallow feature map; sequentially perform perceptual processing on the shallow feature map via each attention residual layer of a plurality of serially connected attention residual layers in the trained hybrid attention super-resolution network model to obtain a deep feature map output by the last attention residual layer; perform an element-wise addition on corresponding pixels of the shallow feature map and the deep feature map via a target residual addition layer of the hybrid attention super-resolution network model to obtain a target feature map; and obtain a detail-enhanced high-resolution image by inputting the target feature map into an upsampling layer of the hybrid attention super-resolution network model.

Further, the processing module 502 is further configured to, for each attention residual layer of the hybrid attention super-resolution network model, in response to determining that the attention residual layer is the first attention residual layer, designate the shallow feature map as a first input feature map of the first attention residual layer and input the first input feature map into the first attention residual layer; or in response to determining that the attention residual layer is not the first attention residual layer, designate an output feature map outputted by a previous attention residual layer as the first input feature map of the attention residual layer and input the first input feature map into the attention residual layer; perform the perceptual processing on the first input feature map via an attention layer of the attention residual layer to obtain a target attention feature map outputted by the attention layer; and perform, via a residual addition layer of the of the attention residual layer, an element-wise addition on corresponding pixels of the target attention feature map and the first input feature map to obtain an output feature map of the attention residual layer, and designate an output feature map of the last attention residual layer as the deep feature map.

Further, the processing module 502 is further configured to, via a processing unit of the attention layer of the attention residual layer and based on a pixel value of each pixel point in the first input feature map and a local binary pattern (LBP) sampling function in the attention layer, input the pixel value of each pixel point into the LBP sampling function to obtain a LBP feature value matrix and store the LBP feature value matrix into the attention layer; input the first input feature map into a first perceptron unit of the attention layer for the perceptual processing to obtain a brightness-based attention feature map; input the LBP feature value matrix into a second perceptron unit of the attention layer for the perceptual processing to obtain a gradient-based attention feature map; input the brightness-based attention feature map and the gradient-based attention feature map into a fusion layer unit of the attention layer for fusion processing to obtain a fused attention feature map; and perform, via an element-wise multiplication unit of the attention layer, element-wise multiplication processing on the fused attention feature map and the first input feature map to obtain the target attention feature map.

Further, each attention residual layer further includes a first convolutional layer, a first activation layer, a second convolutional layer, and a second activation layer; and the processing module 502 is further configured to process the first input feature map by performing convolutional processing through the first convolutional layer, perform activation processing through the first activation layer, perform convolutional processing through the second convolutional layer, perform activation processing through the second activation layer to obtain a second input feature map; and input the second input feature map into the attention layer of the attention residual layer for a subsequent processing.

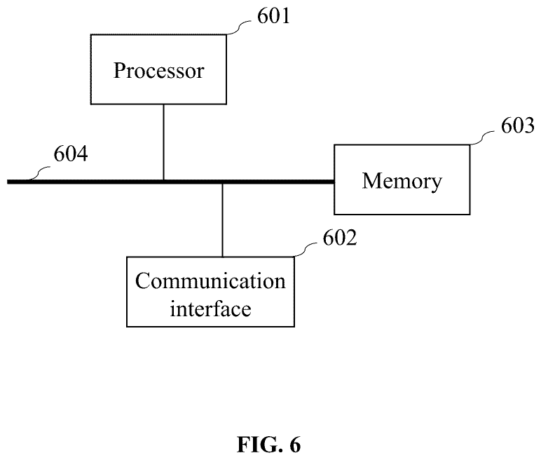

FIG. 6 is a schematic diagram illustrating a structure of an electronic device according to some embodiments of the present disclosure. Based on the foregoing embodiments, the present disclosure further provides an electronic device, as shown in FIG. 6, comprising: a processor 601, a communication interface 602, a memory 603, and a communication bus 604, wherein the processor 601, the communication interface 602, and the memory 603 communicates with each other via the communication bus 604.

The memory 603 is configured to store a computer program, and when the computer program is executed by the processor 601, the processor 601 is caused to perform the following operations.

A target image to be processed is obtained; The detail-enhanced high-resolution image is obtained by processing the target image using a trained hybrid attention super-resolution network model. Specifically, convolutional processing is performed on the target image via a convolutional layer of a trained hybrid attention super-resolution network model to obtain a shallow feature map. Perceptual processing is sequentially performed on the shallow feature map via each attention residual layer of a plurality of serially connected attention residual layers in the trained hybrid attention super-resolution network model to obtain a deep feature map output by the last attention residual layer. An element-wise addition is performed on corresponding pixels of the shallow feature map and the deep feature map via a target residual addition layer of the hybrid attention super-resolution network model to obtain a target feature map. A detail-enhanced high-resolution image is obtained by inputting the target feature map into an upsampling layer of the hybrid attention super-resolution network model.

Further, the perceptual processing sequentially performed on the shallow feature map via each attention residual layer of a plurality of serially connected attention residual layers in the trained hybrid attention super-resolution network model to obtain a deep feature map output by the last attention residual layer includes the following operations.

For each attention residual layer of the hybrid attention super-resolution network model, in response to determining that the attention residual layer is the first attention residual layer, the shallow feature map is designated as a first input feature map of the first attention residual layer, and the first input feature map is input into the first attention residual layer; or in response to determining that the attention residual layer is not the first attention residual layer, an output feature map outputted by a previous attention residual layer is designated as the first input feature map of the attention residual layer, and the first input feature map is input into the attention residual layer. Perceptual processing is performed on the first input feature map via an attention layer of the attention residual layer to obtain a target attention feature map outputted by the attention layer. An element-wise addition is performed, via a residual addition layer of the attention residual layer, on corresponding pixels of the target attention feature map and the first input feature map to obtain an output feature map of the attention residual layer, and an output feature map of the last attention residual layer is designated as the deep feature map.

Further, the perceptual processing performed on the first input feature map via an attention layer of the attention residual layer to obtain a target attention feature map of the attention layer includes the following operations.

Via a processing unit of the attention layer of the attention residual layer and based on a pixel value of each pixel point in the first input feature map and a local binary pattern (LBP) sampling function in the attention layer, the pixel value of each pixel point is input into the LBP sampling function to obtain an LBP feature value matrix, and the LBP feature value matrix is stored into the attention layer.

The first input feature map is input into a first perceptron unit of the attention layer for the perceptual processing to obtain a brightness-based attention feature map. The LBP feature value matrix is input into a second perceptron unit of the attention layer for the perceptual processing to obtain a gradient-based attention feature map. The brightness-based attention feature map and the gradient-based attention feature map are input into a fusion layer unit of the attention layer for fusion processing to obtain a fused attention feature map. Element-wise multiplication processing is performed, via an element-wise multiplication unit of the attention layer, on the fused attention feature map and the first input feature map to obtain the target attention feature map.

Further, each attention residual layer further includes a first convolutional layer, a first activation layer, a second convolutional layer, and a second activation layer; and before the perceptual processing is performed on the first input feature map via an attention layer of the attention residual layer to obtain a target attention feature map outputted by the attention layer, the method further includes the following operations.

The first input feature map is processed by performing convolutional processing through the first convolutional layer, by performing activation processing through the first activation layer, by performing convolutional processing through the second convolutional layer, by performing activation processing through the second activation layer to obtain a second input feature map. The second input feature map is input into the attention layer of the attention residual layer for subsequent processing.

The communication bus of the electronic device described above may be a Peripheral Component Interconnect (PCI) bus or an Extended Industry Standard Architecture (EISA) bus, among others. The communication bus may be divided into an address bus, a data bus, a control bus, or the like. For case of illustration, only a single thick line is shown in the figure, which does not imply that there is only one bus or only one type of bus.

The communication interface 602 is configured to facilitate communication between the electronic device and other devices.

The memory may include a Random Access Memory (RAM), and may also include a Non-Volatile Memory (NVM), such as at least one disk storage device. Optionally, the memory may further include at least one storage device located remotely from the above processor.

The processor may be a general-purpose processor, including a Central Processing Unit (CPU), a Network Processor (NP), or the like; or may be a Digital Signal Processor (DSP), an Application Specific Integrated Circuit (ASIC), a Field Programmable Gate Array (FPGA), or other programmable logic device, discrete gate or transistor logic device, or discrete hardware component.

Based on the foregoing embodiments, the present disclosure further provides a computer-readable storage medium storing a computer program executable by a processor, wherein when the computer program runs on the processor, the processor is caused to perform the following steps.

A target image to be processed is obtained. A detail-enhanced high-resolution image is obtained by processing the target image using a trained hybrid attention super-resolution network model. Specifically, convolutional processing is performed on the target image via a convolutional layer of a trained hybrid attention super-resolution network model to obtain a shallow feature map.

Perceptual processing is sequentially performed on the shallow feature map via each attention residual layer of a plurality of serially connected attention residual layers in the trained hybrid attention super-resolution network model to obtain a deep feature map output by the last attention residual layer. An element-wise addition is performed on corresponding pixels of the shallow feature map and the deep feature map via a target residual addition layer of the hybrid attention super-resolution network model to obtain a target feature map. A detail-enhanced high-resolution image is obtained by inputting the target feature map into an upsampling layer of the hybrid attention super-resolution network model.

Further, the sequentially performing perceptual processing on the shallow feature map via each attention residual layer of a plurality of serially connected attention residual layers in the trained hybrid attention super-resolution network model to obtain a deep feature map output by the last attention residual layer includes the following operations.

For each attention residual layer of the hybrid attention super-resolution network model, in response to a determination that the attention residual layer is the first attention residual layer, the shallow feature map is designated as a first input feature map of the first attention residual layer, and the first input feature map is input into the first attention residual layer; or in response to a determination that the attention residual layer is not the first attention residual layer, an output feature map output by a previous attention residual layer is designated as the first input feature map of the attention residual layer, and the first input feature map is input into the attention residual layer. Perceptual processing is performed on the first input feature map via an attention layer of the attention residual layer to obtain a target attention feature map output by the attention layer. An element-wise addition is performed, via a residual addition layer of the attention residual layer, on corresponding pixels of the target attention feature map and the first input feature map to obtain an output feature map of the attention residual layer. An output feature map of the last attention residual layer is designated as the deep feature map.

Further, the performing the perceptual processing on the first input feature map via an attention layer of the attention residual layer to obtain a target attention feature map includes the following operations.

Based on a pixel value of each pixel in the first input feature map and a local binary pattern (LBP) sampling function in the attention layer, the pixel value of each pixel is input into the LBP sampling function via a processing unit of the attention layer of the attention residual layer, to obtain an LBP feature value matrix, and the LBP feature value matrix is stored into the attention layer;

The first input feature map is input into a first perceptron unit of the attention layer for perceptual processing to obtain a brightness-based attention feature map. The LBP feature value matrix is input into a second perceptron unit of the attention layer for perceptual processing to obtain a gradient-based attention feature map. The brightness-based attention feature map and the gradient-based attention feature map are input into a fusion layer unit of the attention layer for fusion processing to obtain a fused attention feature map. Element-wise multiplication processing is performed, via an element-wise multiplication unit of the attention layer, on the fused attention feature map and the first input feature map to obtain the target attention feature map.

Further, each attention residual layer further includes a first convolutional layer, a first activation layer, a second convolutional layer, and a second activation layer; and before performing the perceptual processing on the first input feature map via an attention layer of the attention residual layer to obtain a target attention feature map outputted by the attention layer, the method further includes the following operations.

The first input feature map is processed by performing convolutional processing via the first convolutional layer, by performing activation processing via the first activation layer, by performing convolutional processing via the second convolutional layer, and by performing activation processing via the second activation layer to obtain a second input feature map. The second input feature map is input into the attention layer of the attention residual layer for subsequent processing.

Those skilled in the art should understand that embodiments of the present disclosure may be provided as a method, a system, or a computer program product. Therefore, the present disclosure may take the form of an entirely hardware embodiment, an entirely software embodiment, or an embodiment combining software and hardware aspects. Furthermore, the present disclosure may take the form of a computer program product implemented on one or more computer-readable storage media containing computer-usable program code, including but not limited to magnetic disk storage, CD-ROM, optical storage, or the like.

The present disclosure is described with reference to flowcharts and/or block diagrams of the method, apparatus (system), and computer program product according to embodiments of the present disclosure. It should be understood that each process and/or block in the flowcharts and/or block diagrams, as well as combinations of processes and/or blocks in the flowcharts and/or block diagrams, may be implemented by computer program instructions. These computer program instructions may be provided to a processor of a general-purpose computer, special-purpose computer, embedded processor, or other programmable data processing apparatus to produce a machine such that instructions executed by the processor of the computer or other programmable data processing apparatus produce a device configured to implement functions specified in one or more processes of the flowcharts and/or blocks of the block diagrams.

These computer program instructions may also be stored in a computer-readable storage medium that can direct a computer or other programmable data processing apparatus to function in a particular manner such that the instructions stored in the computer-readable storage medium produce a manufactured article including instruction means configured to implement functions specified in one or more processes of the flowcharts and/or blocks of the block diagrams.

These computer program instructions may also be loaded into a computer or other programmable data processing apparatus such that a series of operational steps are performed on the computer or other programmable apparatus to produce a computer-implemented process, whereby instructions executed on the computer or other programmable apparatus provide operations configured to implement functions specified in one or more processes of the flowcharts and/or blocks of the block diagrams.

Obviously, those skilled in the art may make various modifications and variations to the present disclosure without departing from the spirit and scope of the present disclosure. Therefore, the present disclosure intends to include these modifications and variations within the scope of the claims and their equivalents.

What is claimed is:

1. An image processing method, wherein the method comprises:
obtaining a target image to be processed; and
obtaining a detail-enhanced high-resolution image by processing the target image using a trained hybrid attention super-resolution network model, wherein the trained hybrid attention super-resolution network model is a machine learning model, and includes a convolutional layer, a plurality of serially connected attention residual layers, a target residual addition layer, and an upsampling layer.

2. The method of claim 1, wherein the obtaining a detail-enhanced high-resolution image by processing the target image using a trained hybrid attention super-resolution network model includes:
performing, via the convolutional layer, convolutional processing on the target image to obtain a shallow feature map;
performing, via the plurality of attention residual layers, perceptual processing on the shallow feature map to obtain a deep feature map;
processing, via the target residual addition layer, the shallow feature map and the deep feature map to obtain a target feature map; and
obtaining the detail-enhanced high-resolution image by processing the target feature map via the upsampling layer.

3. The method of claim 2, wherein the performing, via the plurality of attention residual layers, perceptual processing on the shallow feature map to obtain a deep feature map includes:
for each attention residual layer of the plurality of attention residual layers,
determining a first input feature map of the attention residual layer, wherein the first input feature map is the shallow feature map when the attention residual layer is the first attention residual layer among the plurality of attention residual layers, or the first input feature map is at least one output feature map of at least one previous attention residual layer when the attention residual layer is not the first attention residual layer; and
performing, via the attention residual layer, the perceptual processing on the first input feature map to obtain an output feature map of the attention residual layer; and
designating the output feature map outputted by the last attention residual layer among the plurality of attention residual layers as the deep feature map.

4. The method of claim 3, wherein each attention residual layer includes an attention layer and a residual addition layer, and
the performing, via the attention residual layer, the perceptual processing on the first input feature map to obtain an output feature map of the attention residual layer includes:
performing, via the attention layer, the perceptual processing on the first input feature map to obtain a target attention feature map; and
performing, via the residual addition layer, an element-wise addition on the target attention feature map and the first input feature map to obtain the output feature map of the attention residual layer.

5. The method of claim 4, wherein each attention residual layer further includes a first convolutional layer, a first activation layer, a second convolutional layer, and a second activation layer, and
before performing, via the attention layer, the perceptual processing on the first input feature map to obtain a target attention feature map, the method further includes:
performing, via the first convolutional layer, convolutional processing on the first input feature map to obtain a first convolutional feature map;
performing, via the first activation layer, activation processing on the first convolutional feature map to obtain a first activation feature map;
performing, via the second convolutional layer, convolutional processing on the first activation feature map to obtain a second convolutional feature map;
performing, via the second activation layer, activation processing on the second convolutional feature map to obtain a second input feature map; and
inputting the second input feature map into the attention layer of the attention residual layer for a subsequent processing.

6. The method of claim 5, wherein each attention residual layer further includes a scale prediction layer, and
the performing, via the first convolutional layer, convolutional processing on the first input feature map to obtain a first convolutional feature map includes:
processing, via the scale prediction layer, the first input feature map to obtain a scale feature map; and
performing, via the first convolutional layer, the convolutional processing on the first input feature map and the scale feature map to obtain the first convolutional feature map.

7. The method of claim 4, wherein the attention layer includes a processing unit, a first perceptron unit, a second perceptron unit, a fusion layer unit, and an element-wise multiplication unit, and
the performing, via the attention layer, the perceptual processing on the first input feature map to obtain a target attention feature map includes:
processing, via the processing unit, the first input feature map to a local binary pattern (LBP) feature value matrix;
performing, via the first perceptron unit, the perceptual processing on the first input feature map to obtain a brightness-based attention feature map;
performing, via the second perceptron unit, the perceptual processing on the LBP feature value matrix to obtain a gradient-based attention feature map;
performing, via the fusion layer unit, fusion processing on the brightness-based attention feature map and the gradient-based attention feature map to obtain a fused attention feature map; and
performing, via the element-wise multiplication unit, element-wise multiplication processing on the fused attention feature map and the first input feature map to obtain the target attention feature map.

8. The method of claim 4, wherein each attention residual layer further includes a scale prediction layer, and
the performing, via the attention layer, the perceptual processing on the first input feature map to obtain a target attention feature map includes:
processing, via the scale prediction layer, the first input feature map to obtain a scale feature map; and
performing, via the attention layer, the perceptual processing on the first input feature map and the scale feature map to obtain the target attention feature map.

9. The method of claim 2, wherein the trained hybrid attention super-resolution network model further a noise estimation layer, and
the performing, via the plurality of attention residual layers, perceptual processing on the shallow feature map to obtain a deep feature map includes:
processing, via the noise estimation layer, the target image to obtain a noise estimation image; and
performing, via the plurality of attention residual layers, the perceptual processing on the shallow feature map and the noise estimation image to obtain the deep feature map.

10. The method of claim 1, further comprising:
controlling a terminal device to display the detail-enhanced high-resolution image.

11. An image processing system, comprising:
at least one storage device including a set of instructions; and
at least one processor in communication with the at least one storage device, wherein when executing the set of instructions, the at least one processor is configured to direct the system to perform operations including:
obtaining a target image to be processed; and
obtaining a detail-enhanced high-resolution image by processing the target image using a trained hybrid attention super-resolution network model, wherein the trained hybrid attention super-resolution network model is a machine learning model, and includes a convolutional layer, a plurality of serially connected attention residual layers, a target residual addition layer, and an upsampling layer.

12. The system of claim 11, wherein the obtaining a detail-enhanced high-resolution image by processing the target image using a trained hybrid attention super-resolution network model includes:
performing, via the convolutional layer, convolutional processing on the target image to obtain a shallow feature map;
performing, via the plurality of attention residual layers, perceptual processing on the shallow feature map to obtain a deep feature map;
processing, via the target residual addition layer, the shallow feature map and the deep feature map to obtain a target feature map; and
obtaining the detail-enhanced high-resolution image by processing the target feature map via the upsampling layer.

13. The system of claim 12, wherein the performing, via the plurality of attention residual layers, perceptual processing on the shallow feature map to obtain a deep feature map includes:
for each attention residual layer of the plurality of attention residual layers,
determining a first input feature map of the attention residual layer, wherein the first input feature map is the shallow feature map when the attention residual layer is the first attention residual layer among the plurality of attention residual layers, or the first input feature map is at least one output feature map of at least one previous attention residual layer when the attention residual layer is not the first attention residual layer; and
performing, via the attention residual layer, the perceptual processing on the first input feature map to obtain an output feature map of the attention residual layer; and
designating the output feature map outputted by the last attention residual layer among the plurality of attention residual layers as the deep feature map.

14. The system of claim 13, wherein each attention residual layer includes an attention layer and a residual addition layer, and
the performing, via the attention residual layer, the perceptual processing on the first input feature map to obtain an output feature map of the attention residual layer includes:
performing, via the attention layer, the perceptual processing on the first input feature map to obtain a target attention feature map; and
performing, via the residual addition layer, an element-wise addition on the target attention feature map and the first input feature map to obtain the output feature map of the attention residual layer.

15. The system of claim 14, wherein each attention residual layer further includes a first convolutional layer, a first activation layer, a second convolutional layer, and a second activation layer, and
the performing, via the attention layer, the perceptual processing on the first input feature map to obtain a target attention feature map includes:
performing, via the first convolutional layer, convolutional processing on the first input feature map to obtain a first convolutional feature map;
performing, via the first activation layer, activation processing on the first convolutional feature map to obtain a first activation feature map;
performing, via the second convolutional layer, convolutional processing on the first activation feature map to obtain a second convolutional feature map;
performing, via the second activation layer, activation processing on the second convolutional feature map to obtain a second input feature map; and
inputting the second input feature map into the attention layer of the attention residual layer for a subsequent processing.

16. The system of claim 15, wherein each attention residual layer further includes a scale prediction layer, and
the performing, via the first convolutional layer, convolutional processing on the first input feature map to obtain a first convolutional feature map includes:
processing, via the scale prediction layer, the first input feature map to obtain a scale feature map; and
performing, via the first convolutional layer, the convolutional processing on the first input feature map and the scale feature map to obtain the first convolutional feature map.

17. The system of claim 14, wherein the attention layer includes a processing unit, a first perceptron unit, a second perceptron unit, a fusion layer unit, and an element-wise multiplication unit, and
the performing, via the attention layer, the perceptual processing on the first input feature map to obtain a target attention feature map includes:
processing, via the processing unit, the first input feature map to a local binary pattern (LBP) feature value matrix;
performing, via the first perceptron unit, the perceptual processing on the first input feature map to obtain a brightness-based attention feature map;
performing, via the second perceptron unit, the perceptual processing on the LBP feature value matrix to obtain a gradient-based attention feature map;
performing, via the fusion layer unit, fusion processing on the brightness-based attention feature map and the gradient-based attention feature map to obtain a fused attention feature map; and
performing, via the element-wise multiplication unit, element-wise multiplication processing on the fused attention feature map and the first input feature map to obtain the target attention feature map.

18. The system of claim 14, wherein each attention residual layer further includes a scale prediction layer, and
the performing, via the attention layer, the perceptual processing on the first input feature map to obtain a target attention feature map includes:
processing, via the scale prediction layer, the first input feature map to obtain a scale feature map; and
performing, via the attention layer, the perceptual processing on the first input feature map and the scale feature map to obtain the target attention feature map.

19. The system of claim 12, wherein the trained hybrid attention super-resolution network model further a noise estimation layer, and
the performing, via the plurality of attention residual layers, perceptual processing on the shallow feature map to obtain a deep feature map includes:
processing, via the noise estimation layer, the target image to obtain a noise estimation image; and
performing, via the plurality of attention residual layers, the perceptual processing on the shallow feature map and the noise estimation image to obtain the deep feature map.

20. A non-transitory computer readable medium, comprising at least one set of instructions, wherein when executed by one or more processors of a computing device, the at least one set of instructions causes the computing device to perform a method, the method comprising:
obtaining a target image to be processed; and
obtaining a detail-enhanced high-resolution image by processing the target image using a trained hybrid attention super-resolution network model, wherein the trained hybrid attention super-resolution network model is a machine learning model, and includes a convolutional layer, a plurality of serially connected attention residual layers, a target residual addition layer, and an upsampling layer.
